(19) United States
(12) Patent Application Publication
(10) Pub. No.: US 2010/0160452 A1
(43) Pub. Date: Jun. 24, 2010

(54) HIGH ALCOHOL-CONTENT FOAMS

(76) Inventors: Molly I-Chin Busby, Midland, MI (US); Christopher J. Tucker, Midland, MI (US)

Correspondence Address: The Dow Chemical Company, P.O. BOX 1967, Midland, MI, 48641, US

(21) Appl. No.: 12/444,110

(22) PCT Filed: Oct. 2, 2007
(86) PCT No.: PCT/US07/80152

§ 371 Date: Mar. 12, 2010

Related U.S. Application Data
(60) Provisional application No. 60/848,666, filed on Oct. 2, 2006.

(51) Int. Cl. A01N 31/00; A01P 15/00

(52) U.S. Cl. 514/724

(57) ABSTRACT

A foamable aqueous composition having alcohol and at least one water soluble polymer.

### FIELD

The present invention relates to aqueous foams containing relatively high concentrations of alcohol.

### BACKGROUND

In personal care applications, simple alcohols (C1-C6), such as ethanol and isopropanol, are known to be efficient germ killers. However, such alcohols evaporate quickly when applied directly to skin, thus lessening their effectiveness. Although attempts have been made to use foams as a delivery vehicle to provide longer contact time, i.e., for use as a hand sanitizer, alcohols disrupt foam structure. In fact, at concentrations of simple alcohols beyond 40%, traditional foaming surfactants cannot create a foam. More complex anti-microbial foams exist, but there is an unmet need in the market for a foamable composition with relatively high concentrations of alcohol.

### SUMMARY

In one embodiment, the present invention provides a foamable aqueous composition having more than 50 wt. %, preferably more than 60 wt. %, of an alcohol, and a water soluble polymer.

### DETAILED DESCRIPTION

In one embodiment, the present invention provides a foamable aqueous composition comprising more than 50 wt. % of an alcohol, and a water soluble polymer. Unless otherwise stated, all percentages, %, are by weight based on the total weight of the composition.

“Alcohol” refers to cosmetically acceptable C1-C6 alcohols. In one embodiment, the alcohol is at least one of methanol, ethanol, isopropanol, n-propanol, n-butanol, iso-butanol, t-butanol, n-pentanol, iso-pentanol, and n-hexanol. In one embodiment, the alcohol is a mixture of alcohols. In one embodiment, the alcohol is cosmetically acceptable. “Cosmetically acceptable” refers to ingredients typically used in personal care compositions, and is intended to underscore that materials that are toxic, irritating, or unpleasant smelling when present in the amounts typically found in personal care compositions are not contemplated as part of the present invention. In a preferred embodiment, the alcohol is at least one of isopropanol or ethanol. In the most preferred embodiment, the alcohol is ethanol.

In one embodiment, the composition comprises more than 60 wt. % of an alcohol. In one embodiment, the composition comprises about 65 wt. % of an alcohol. In another embodiment, the composition comprises more than 65 wt. % of an alcohol. The alcohol is present from about 50 wt. % to about 90 wt. %, more preferably, about 55 wt. % to about 80 wt. %, and most preferably from about 60 wt. % to about 70 wt. %.

In one embodiment, the foam can be formed from alcohol, water, and water soluble polymer. In other embodiments, the composition further comprises a surfactant. The surfactant may be cationic, anionic, nonionic, or amphoteric. In one embodiment, the surfactant is present in an amount from about 0.1 to about 5 wt. %,

In one embodiment, the surfactant is a fluorinated surfactant. In a preferred embodiment, the fluorinated surfactant is an ethoxylated nonionic fluorosurfactant. One such preferred surfactant is ZONYL FS Fluorosurfactant from DuPont. In one embodiment, the fluorinated surfactant is present in an amount from about 0.01 to about 5 wt. %, preferably from about 1.0 to about 2.0 wt. %.

In one embodiment, the surfactant is a silicone surfactant. In one embodiment, the surfactant is a betaine. In one embodiment, the surfactant is sodium myristate. In one embodiment, the surfactant is sodium dodecylbenzenesulfonate. One preferred surfactant is cocamidopropyl betaine.

The surfactants may be used in addition to the fluorinated surfactant. In one embodiment, the additional surfactant is present in an amount from about 0.1 to about 5.0 wt. %, preferably in an amount of about 4.0 wt. %.

The water soluble polymer in the present composition may be one or more of Gum Arabic, xanthan gum, gum karaya, gum tragacanth, gum ghatti, guar gum, exudates gums, seaweed gums, seed gums, microbial gums, carrageenan, dextran, gelatin, alginates, pectins, starches, polysaccharides, homo- or copolymers of ethylene imine, acrylic acid, acrylamide, vinylalcohol, vinylacetate, vinylpyrrolidone, vinyloxazozolidone, vinylmethyloxazolidone, ethylene sulfonic acid, vinylamine, vinylpyrridine hydroxypropylmethylcellulose, methylcellulose, hydroxypropylcellulose, quaternary amine substituted hydroxyethylcellulose, polyethyleneglycol, and polyalkyleneglycol. In one embodiment, the water soluble polymer is cosmetically acceptable. In one embodiment, the water soluble polymer is a starch or a cellulose-based polymer, for instance hydroxyethylcellulose, hydroxypropylcellulose, hydroxypropylmethylcellulose, methylcellulose, ethylhydroxyethylcellulose, carboxymethylcellulose and quaternized cellulose derivatives.

In a preferred embodiment, the water soluble polymer is cationically modified hydroxyethyl cellulose. One such commercially available cationically modified hydroxyethyl cellulose is the UCAR JR family from The Dow Chemical Company, defined in the CTFA dictionary as quaternary ammonium compounds of hydroxyethylcellulose which have been reacted with an epoxide (in particular epichlorohydrin) substituted with a trimethylammonium group, % Nitrogen=1.5-2.2. Particularly preferred is UCAR JR 125 cationically modified hydroxyethyl cellulose from The Dow Chemical Company.

In one embodiment, the water soluble polymer is present in an amount from about 0.01 to about 3 wt. %, preferably in an amount from about 0.2 to about 2 wt. %.

In some embodiments, the composition of the present invention has a viscosity of less than 250 cPs. In some embodiments of the present invention, the compositions have viscosities of less than 50 cPs.

Other optional cosmetically acceptable ingredients are contemplated for personal care compositions of the present invention.

Dyes include water-soluble dyes such as copper sulfate, iron sulfate, water-soluble sulfopolyesters, rhodamines, natural dyes, for instance carotene and beetroot juice, methylene blue, caramel, the disodium salt of tartrazine and the disodium salt of fuschin, and mixtures thereof. Liposoluble dyes may also optionally be used.

Fragrances include any component which provides a pleasant scent. Fragrances are generally aldehydes or ketones, and often oils obtained by extraction of natural substances or synthetically produced. Often, fragrances are accompanied by auxiliary materials, such as fixatives, extenders, stabilizers and solvents.

Biocides include antimicrobials, bactericides, fungicides, algaecides, mildicides, disinfectants, antiseptics, and insecticides. The present composition may further comprise a biocide selected from benzalkonium chloride, benzelthonium chloride, phenols, and triclosan.

The amount of optional ingredients effective for achieving the desired property provided by such ingredients can be readily determined by one skilled in the art.

The present invention provides a new method of creating foam in aqueous solutions with higher alcohol concentration levels. It is found that when a water soluble polymer is present in an aqueous composition, the alcohol containing composition can be made foamable. Many known means, such as applicators, can be utilized to make foam from aqueous compositions, particularly in the hand sanitizer arena.

In such sanitizer products, the compositions usually have a viscosity of less than 250 cPs and sometimes less than 50 cPs. Through an applicator, the composition can be applied to skin as foam. In a preferred embodiment, the foam has at least 60 wt. % ethanol, isopropanol, or mixtures thereof. Since the inventive compositions contain a high concentration of alcohol, i.e. at least 60 wt. %, and the foam can stay on the skin for an extended period of time without drying off quickly, an intended purpose of killing bacteria and germs on the skin can be achieved. The present compositions also tend to form a thin coating once applied to skin. This effect further prevents the vaporization or drying off of the alcohols.

The present composition may also be used in the medical field as pre-surgical scrub, skin protection and cleansers, pet no wash disinfectant cleaner, multipurpose foam disinfectant cleaner, bathroom foam disinfectant cleaner, mining floatation, other general cleanings and utilize foamed alcohol for ore recovery.

The present invention may also find application as disinfecting foamed carpet cleaner. Traditional carpet cleaning with spray techniques require greater volumes of cleaner and processing time to clean the carpet because liquid soaks into the carpet backing rather than just wetting the surface. Prolonged dampness on carpet may cause mildew and bacteria growth. However, foam increases the liquid surface area and volume of the polymer binder compared to the traditional spray techniques so less cleaning active ingredients are used in the application.

### EXAMPLES

The following examples are for illustrative purposes only and are not intended to limit the scope of the present invention.

### Example 1

Exemplary foamable personal care compositions according to the present invention contain the components recited in TABLE 1:

TABLE 1

| | Batch 1 | Batch 2 | Batch 3 | Batch 4 |
|---|---|---|---|---|
| ZONYL ® FS Fluorosurfactant | 2.0 | 2.0 | 2.0 | 2.0 |
| (DuPont) | | | | |
| Hexadecanol | 1.0 | — | — | — |
| Cationic Hydroxyethyl | 0.2 | 0.2 | 1.0 | 2.0 |
| Cellulose, UCARE JR 125 | | | | |
| (The Dow Chemical | | | | |
| Company) | | | | |
| Cocamidopropyl Betaine | 4.0 | 4.0 | 4.0 | 4.0 |
| Ethanol | 65.0 | 65.0 | 65.0 | 65.0 |
| Water | 27.8 | 28.8 | 28.0 | 27 |

All numerals given in Table 1 are wt. %.

The UCARE JR 125 cationic hydroxyethyl cellulose is dispersed in ethanol, then water is added to hydrate. After the cationic hydroxyethyl cellulose is completely dissolved, the fluorosufactant is added, followed by the cocamidopropyl betaine.

### Example 2 (Comparative)

Comparative compositions contain the components recited in TABLE 2:

TABLE 2

| | Batch A | Batch B |
|---|---|---|
| Fluorosurfactant | 2.0 | 1.0 |
| Hexadecanol | 1.0 | 1.0 |
| Cationic Hydroxyethyl Cellulose | — | — |
| Cocamidopropyl Betaine | 4.0 | 4.0 |
| Ethanol | 65.0 | 65.0 |
| Water | 28 | 29 |

All numerals given in Table 1 are wt. %.

“Fluorosurfactant,” “Cationic Hydroxyethyl Cellulose,” and Cocamidopropyl Betaine are as above.

### Example 3

Inventive and comparative compositions were prepared using components and protocol substantially similar to that described in Examples 1 and 2. Each of the six (6) samples was placed in a bottle equipped with a conventional applicator. With respect to Comparative Batches A and B, no foam was observed when the applicator was activated to pump the aqueous composition out of the bottle. In contrast, dense creamy foam was observed with respect to inventive Batches 1-4.

### Example 4

Inventive compositions were prepared using the components and protocol substantially similar to that described in Example 1. Batches 1-4 were tested for their viscosity.

Viscosity is measured using a cone and plate viscometer by first setting the temperature bath to 25° C.; and then waiting for the sample cup to reach equilibrium. Cone spindle CP-40 is then placed onto the instrument. 0.5 milliliters of the sample is then placed into the center of the cup. The cup is then connected to the viscometer, and sample is allowed to reach the set temperature (typically 15 minutes maximum). Motor is then turned on and its speed is adjusted until the torque reading is between 10% and 100%. Once the measurement reaches steady state, the viscosity reading in both % torque and centipoises (cP) can be recorded. Using substantially this procedure, the viscosities determined were: Batch 1=4.9 cPs, Batch 2=4.7 cPs, Batch 3=38 cPs, and Batch 4=207 cPs.

It is understood that the present invention is not limited to the embodiments specifically disclosed and exemplified herein. Various modifications of the invention will be apparent to those skilled in the art. Such changes and modifications may be made without departing from the scope of the appended claims.

Moreover, each recited range includes all combinations and subcombinations of ranges, as well as specific numerals contained therein. Additionally, the disclosures of each patent, patent application, and publication cited or described in this document are hereby incorporated herein by reference, in their entireties.

1. A foamable aqueous composition comprising more than 50 wt. % of an alcohol, a fluorinated surfactant, and a water soluble polymer, wherein the water soluble polymer is present in an amount from about 0.01 to about 3 wt. %.

2-3. (canceled)

4. The composition of claim 1, wherein the surfactant is an ethoxylated nonionic fluorosurfactant.

5. The composition of claim 1, wherein the surfactant is present in an amount from about 0.01 to about 5 wt. %.

6. The composition of claim 1, wherein the fluorinated surfactant is present in an amount from about 1.0 to about 2.0 wt. %.

7. The composition of claim 1, further comprising an additional surfactant comprising at least one of an anionic surfactant, nonionic surfactant, amphoteric surfactant, or silicone surfactant.

8. The composition of claim 7, wherein the additional surfactant is ammonium lauryl sulfate, ammonium laureth sulfate, sodium lauryl sulfate, sodium laureth sulfate, sodium trideceth sulfate, sodium dodecylbenzenesulfonate. cocamidopropyl betaine, alkanolamides, alkyl polyglucosides, dimethicone, cyclopentasiloxane, or amodimethicone.

9. The composition of claim 7, wherein the additional surfactant is present in an amount from about 0.1 to about 5.0 wt. %.

10. The composition of claim 7, wherein the additional surfactant is present in an amount of about 4.0 wt. %.

11. The composition of claim 1, wherein the alcohol is at least one of ethanol, isopropanol, methanol, n-propanol, n-butanol, iso-butanol, t-butanol, n-pentanol, iso-pentanol, and n-hexanol.

12. The composition of claim 1, wherein the alcohol is ethanol, isopropanol, or mixtures thereof.

13. (canceled)

14. The composition of claim 1, wherein the composition comprises more than 60 wt. % of alcohol.

15. The composition of claim 1, wherein the composition comprises about 65 wt. % of alcohol.

16. The composition of claim 1, wherein the composition comprises more than 65 wt. % of alcohol.

17. The composition of claim 1, wherein the water soluble polymer is at least one of Gum Arabic, xanthan gum, gum karaya, gum tragacanth, gum ghatti, guar gum, exudates gums, seaweed gums, seed gums, microbial gums, carrageenan, dextran, gelatin, alginates, pectins, starches, polysaccharides, homo- or copolymers of ethylene imine, acrylic acid, acrylamide, vinylalcohol, vinylacetate, vinylpyrrolidone, vinyloxazozolidone, vinylmethyloxazolidone, ethylene sulfonic acid, vinylamine, vinylpyrridine hydroxypropylmethylcellulose, methylcellulose, hydroxypropylcellulose, quaternary amine substituted hydroxyethylcellulose, polyethyleneglycol, or polyalkyleneglycol.

18. The composition of claim 1, wherein the water soluble polymer is cationically modified hydroxyethyl cellulose.

19. (canceled)

20. The composition of claim 1, wherein the water soluble polymer is present in an amount from about 0.2 to about 2 wt. %.

21. The personal care composition of claim 1, further comprising at least one of hexadecanol, a biocide, or water, wherein, if present, the amount of water is less than 30 wt. %.

22-24. (canceled)

25. The composition of claim 1, comprising:
a fluorinated surfactant;
a betaine surfactant;
more than 60 wt. % of C1-C6 alcohol, and
cationically modified hydroxyethyl cellulose.
